(19) United States
(12) Patent Application Publication
(10) Pub. No.: US 2024/0211968 A1
(43) Pub. Date: Jun. 27, 2024

(54) DEVICE AND METHOD OF AUTHENTICATING A COMPONENT AGAINST REFERENCE DATA

(71) Applicant: ADAPTIX LTD, Begbroke (GB)

(72) Inventor: Vadim Soloviev

(21) Appl. No.: 18/599,175

(22) Filed: Mar. 7, 2024

Related U.S. Application Data
(63) Continuation of application No. PCT/IB2022/057878, filed on Aug. 23, 2022.

(30) Foreign Application Priority Data
Sep. 7, 2021 (GB) 2112739.4

(51) Int. Cl. G06Q 30/018

(52) U.S. Cl. CPC G06Q 30/0185

(57) ABSTRACT

It is known to embed fiduciary markers in a composite component, and to image said component with x-rays to determine the spatial location of the fiduciary markers. However, comparing two such “point cloud patterns” to determine whether they correspond is not a simple exercise; in particular, due to the nature of image reconstruction with limited angle acquisition in digital tomosynthesis, depths of fiduciary markers are resolved only approximately, while lateral resolution is usually significantly higher. The present invention provides a device and method of authenticating a component against reference data by choosing a starting point rotation centre and comparing the distances to its nearest neighbours with those from a reference dataset, and then calculating a rotation matrix based on this comparison. In this way, composite components can be tracked by their unique ‘fingerprint’ such that they can be validated prior to use.

### RELATED APPLICATIONS

This application claims the benefit under 35 U.S.C. § 120, and is a continuation, of co-pending International Application PCT/IB2022/057878, filed Aug. 23, 2022 and designating the US, which claims priority to GB Application 2112739.4, filed Sep. 7, 2021, such GB Applications also being claimed priority to under 35 U.S.C. § 119. These GB and International applications are incorporated by reference herein in their entireties.

### FIELD

The present invention relates generally to a device and a method of authenticating a component against reference data and finds particular, although not exclusive, utility in identifying counterfeit goods in the aerospace sector.

### BACKGROUND

There is a clear growth in the use of complex composite parts because of their unique engineering capabilities. This use of high-cost and complex composites provokes the use of counterfeit parts. Counterfeits not performing to the stringent organisational and government standards can lead to injury or death in the aerospace sector.

It is known to embed fiduciary markers in a composite component, and to image said component with x-rays to determine the spatial location of the fiduciary markers. However, comparing two such “point cloud patterns” to determine whether they correspond is not a simple exercise, and is known in pattern recognition fields as “point cloud registration”.

A large body of mathematical literature exists on the subject of point cloud registration; however, point cloud registration involving digital tomosynthesis has specific features, which makes it distinct from point cloud registration in computer vision, for instance. Due to the nature of image reconstruction with limited angle acquisition in digital tomosynthesis, depths of fiduciary markers are resolved only approximately, while lateral resolution is usually significantly higher. That is, a detected point cloud pattern might look different from a matching pattern even though these point clouds are physically the same.

### SUMMARY

According to the present invention, there is provided a method of authenticating a component against reference data, the component provided with a plurality of fiducial markers embedded therein, the reference data comprising: a reference dataset comprising a plurality of three-dimensional locations of respective reference fiducial markers in a reference component; a rotation centre corresponding to one of the plurality of three-dimensional locations; and respective reference distances between the rotation centre and N nearest-neighbour three-dimensional locations of the plurality of three-dimensional locations to the rotational centre, where N is at least three; the method comprising the steps of: (a) providing a test dataset comprising a plurality of approximate three-dimensional locations of test fiducial markers in a test component; (b) for a first one of the plurality of approximate three-dimensional locations, determining respective first approximate distances between the first one of the plurality of approximate three-dimensional locations and N nearest-neighbour approximate three-dimensional locations of the plurality of approximate three-dimensional locations; (c) comparing the first approximate distances to the reference distances to establish whether the first one of the plurality of approximate three-dimensional locations corresponds to the rotation centre; (d) if the first one of the plurality of approximate three-dimensional locations corresponds to the rotation centre, calculating a rotation matrix between the test dataset and the reference dataset, about the rotation centre, based on the N nearest-neighbour approximate three-dimensional locations of the plurality of approximate three-dimensional locations and the N nearest-neighbour three-dimensional locations of the plurality of three-dimensional locations; (e) using the rotation matrix to attempt to register the plurality of approximate three-dimensional locations with the plurality of three-dimensional locations; and (f) estimating an accuracy of the attempted registration to establish authenticity of the test component.

In this way, composite components can be tracked by their unique ‘fingerprint’ such that they can be validated prior to use.

Authenticating may comprise confirming, to within a range of certainty, that a component is authentic.

The plurality of three-dimensional locations of respective reference fiducial markers may comprise three cartesian coordinates, or any other means of identifying their respective locations in three dimensions. The locations may be relative to some datum; however, it is to be appreciated that the invention works with any chosen datum, as authentication is by means of relative positions of the fiducial markers.

The reference component may comprise the test component, and vice versa. For example, the reference component may be the test component. For instance, the location of fiducial markers may be determined in a component, this data becoming the reference data; at a later date, the component may be tested as the test component.

The reference component and/or test component may be formed by introducing embedded fiducial markers within the component upon manufacture, with this fingerprint then imaged and entered into a cloud-based database. These fiducial formations (the fingerprint) would be physically unclonable to deter and prevent counterfeit composite products entering the supply chain. The imaging system would then check against this database during verification inspections.

This physical fingerprint is integral to the device (and hence cannot be moved between parts). By integrating the fingerprint that is read by this method, there is the opportunity to capture data about the asset throughout its life, and in particular, should the device be transferred between airframes.

The rotation centre may simply be co-located with one of the plurality of three-dimensional locations.

The reference dataset may comprise an ordered list of locations of fiducial markers, ordered by their proximity to the rotation centre. For example, the reference dataset may comprise a location of the rotation centre, followed by the location of the 1st nearest neighbour to the rotation centre, followed by the location of the 2nd nearest neighbour to the rotation centre, etc. However, it is to be appreciated that any ordering, or none, is also possible.

The reference dataset may comprise a vector matrix.

The reference distances may be explicitly recited in the reference data, for instance having a one-to-one correspondence with the N nearest-neighbour three-dimensional locations of the plurality of three-dimensional locations to the rotational centre in the reference dataset. However, it is also envisaged that the reference distances may merely be implicit from the reference data; that is, the reference distances may be calculatable from the reference dataset, and not be recited in the reference data.

N may be any integer greater than or equal to three, in particular greater than or equal to five, more particularly greater than or equal to 10, for example greater than or equal to twenty, fifty or a hundred.

N may be at most half a total number of the plurality of three-dimensional locations. For example, N may be at most a hundred, in particular at most fifty, more particularly at most twenty, for example at most ten or five.

The reference data may further comprise respective reference angles comprising an angle between a first line from the rotation centre to a first one of the N nearest-neighbour fiducial markers, and a second line from the rotation centre to a second one of the N nearest-neighbour fiducial markers. At least one reference angle may be provided for each of the N nearest-neighbour fiducial markers; however, in some arrangements, more than one reference angle may be provided for a fiducial marker.

In this way, the position of each nearest neighbour may be established, not merely their respective distances. As with the reference distances, the reference angles may be implicitly contained within the reference dataset, and/or may be explicitly recited in the reference data.

The method may further comprise determining test angles from the test dataset in a similar manner, and comparing the test angles with the reference angles to establish whether the first one of the plurality of approximate three-dimensional locations corresponds to the rotation centre.

Having fiducial markers embedded inside may mean that the fiducial markers are disposed throughout the component, and may be spaced from the surface of said component.

Providing the test dataset may comprise taking a plurality of transmission images (such as x-ray images) of the test component and reconstructing a three-dimensional image of the test component to identify the approximate three-dimensional locations of the fiducial markers. Similarly, the reference data and/or reference dataset may be obtained in the same way.

In particular, the x-ray images may be obtained via digital tomosynthesis using a flat panel array of x-ray emitters.

The test dataset may be substantially similar to the reference dataset, and may possess a similar format.

The test dataset may include an indication of a standard deviation, variance and/or error associated with each approximate location. Alternatively, a standard deviation, variance and/or error may be applied to each approximate location, based on the means by which the test dataset is provided.

The first one of the plurality of approximate three-dimensional locations corresponding to the rotation centre may mean that N nearest-neighbour approximate three-dimensional locations of the plurality of approximate three-dimensional locations are within an acceptable limit of the N nearest-neighbour three-dimensional locations of the plurality of three-dimensional locations. For instance, this acceptable limit may be within an error associated with the locations, and/or within one to five variances or standard deviations.

Calculating the rotation matrix may comprise calculating the rotation matrix:

$$A = ( \begin{matrix}{a}_{00} & {a}_{01} & {a}_{02} \\ {a}_{10} & {a}_{11} & {a}_{12} \\ {a}_{20} & {a}_{21} & {a}_{22}\end{matrix} )$$

by solving the equation:

$${a}_{i} = {( {BB}^{T} + α I )}^{- 1} {Bc}_{i}$$

where:

$${a}_{i} = {( {a}_{i 0} , {a}_{i 1} , {a}_{i 2} )}^{T}$$

and in which:

$${c}_{i} = {( {c}_{i}^{( 0 )} , … , {c}_{i}^{( n )} )}^{T}$$

and:

$$C = ( \begin{matrix}{c}_{0}^{( 0 )} & … & {c}_{0}^{( n )} \\ {c}_{1}^{( 0 )} & … & {c}_{1}^{( n )} \\ {c}_{2}^{( 0 )} & … & {c}_{2}^{( n )}\end{matrix} )$$

is a matrix containing three-dimensional coordinates of n locations in the reference dataset, and:

$$B = ( \begin{matrix}{b}_{0}^{( 0 )} & … & {b}_{0}^{( n )} \\ {b}_{1}^{( 0 )} & … & {b}_{1}^{( n )} \\ {b}_{2}^{( 0 )} & … & {b}_{2}^{( n )}\end{matrix} )$$

is a matrix containing three-dimensional coordinates of the corresponding n locations in the test dataset, I is the identity matrix, α is a regularization parameter. However, in some arrangements matrix B may relate to the reference dataset and matrix C may relate to the test data set.

Although the matrix BBT is square, it might not be invertible in a numerical sense. That is because some points in the cloud described by B can be located very near to each other. That means that from a numerical point of view some rows of the matrix B could be almost the identical. This results in rank-deficiency of the matrix BBT, and rank deficient matrices are not invertible. Therefore, it is well established that to find the inverse of the matrix BBT we have to regularize it. Regularization can be done in variety of ways, and a large body of literature is devoted to this problem.

For convenience the present invention uses the Tikhonov regularization, in which a small number α is added to the diagonal of the matrix BBT. Because the diagonal matrix αI is clearly invertible, the sum BB^{T}+αI is invertible too. However, the regularization parameter α must be small enough to not significantly affect the solution. α may be between zero and one; preferably α may be less than 10-6, for instance as low as 10-9. However, α should not be zero, as this would lead to no regularization; in fact, α should not be too small as the degree of regularization would be imperceptible with respect to the errors/noise in the acquired datasets. Accordingly, in preferred arrangements, a should be at least 10-12. In many cases the regularization parameter is chosen empirically and/or by trial and error. For example, if elements of the matrix BBT are of the order of 1, i.e. O(1), and we are looking for solution with accuracy, say, 10⁻⁶, then it is sufficient to set α=10⁻⁶.

In the above example, the three-dimensional coordinates in each matrix may be sorted with respect to corresponding distances to the rotation centre.

Using the rotation matrix to attempt to register the plurality of approximate three-dimensional locations with the plurality of three-dimensional locations may comprise using A to operate on B.

Estimating an accuracy of the attempted registration may comprise comparing the result of the product AB with C; that is, comparing the attempted registration of one of either the reference or test datasets with the other of the reference or test datasets.

The accuracy may be determined in a statistical sense. In reconstruction, slices inclusions (fiducials) appear as blobs occupying some small volumes. The present invention may represent them as points by computing their mass-centres (treating the intensity of a pixel as a “mass”). The present invention may identify a bounding box for each inclusion. When a registered point from another cloud falls inside such a bounding box, a perfect match is found. For example, this could be represented as a 100% match (having a probability of 1). As noted above, a half of the size of a bounding box along each axis can be chosen as one standard deviation of the Gaussian. That is, the Gaussian represents an uncertainty of the inclusion location. If the registered point falls into the volume of two standard deviation, it may be considered a match, but with probability less the 100% (probability <1). Because the area under the Gaussian at one standard deviation is about 68%, and area under two standard deviation is about 95%, then, it can be said that in this case the probability of a match is about (95−68)/68=0.4. For instance, for three standard deviations (area=99.7%) it would be (99.7−95)/68=0.07. This gives a statistical estimation of a match. Probabilities of a match higher than, say, 0.65 may be considered to be acceptable (less than two standard deviation), but other limits may also be chosen if desired.

Because the Gaussian representing a location of an inclusion is not always symmetrical, i.e. standard deviations along each axis are different (in general), the probability average (arithmetical or a norm) may be computed, the lowest probability may be taken, and/or an average bounding box (cubic) may be considered.

Steps (b) to (f) may be repeated for a second, third, fourth and/or fifth one of the plurality of approximate three-dimensional locations. In fact, steps (b) to (f) may be repeated any number of times, up to the total number of approximate three-dimensional locations in the test dataset. However, in some cases steps (b) to (f) may be repeated half or a third the total number of approximate three-dimensional locations in the test dataset.

The method may further comprise the step of comparing the accuracy starting from the first one of the plurality of approximate three-dimensional locations with the accuracy starting from the second one of the plurality of approximate three-dimensional locations, and optionally selecting the higher accuracy, and/or comparing all accuracies so calculated and assessing the statistical significance of their accuracy.

If the first one of the plurality of approximate three-dimensional locations does not correspond to the rotation centre, steps (d) to (f) may be skipped for the first one of the plurality of approximate three-dimensional locations, before proceeding with steps (b) to (f) for the second one of the plurality of approximate three-dimensional locations. The same principles could be applied to others of the plurality of approximate three-dimensional locations, such as the third, eighth, etc.

According to a second aspect of the present invention, there is provided an authentication device for authenticating a component against reference data, the component provided with a plurality of fiducial markers embedded therein, the device comprising: communication equipment for accessing reference data, the reference data comprising: a reference dataset comprising a plurality of three-dimensional locations of respective reference fiducial markers in a reference component; a rotation centre corresponding to one of the plurality of three-dimensional locations; and respective reference distances between the rotation centre and N nearest-neighbour three-dimensional locations of the plurality of three-dimensional locations to the rotational centre, where N is at least three; x-ray apparatus for acquiring a test dataset, the test dataset comprising a plurality of approximate three-dimensional locations of test fiducial markers in a test component; a processor unit for carrying out the steps of: for a first one of the plurality of approximate three-dimensional locations, determining respective first approximate distances between the first one of the plurality of approximate three-dimensional locations and N nearest-neighbour approximate three-dimensional locations of the plurality of approximate three-dimensional locations; comparing the first approximate distances to the reference distances to establish whether the first one of the plurality of approximate three-dimensional locations corresponds to the rotation centre; if the first one of the plurality of approximate three-dimensional locations corresponds to the rotation centre, calculating a rotation matrix between the test dataset and the reference dataset, about the rotation centre, based on the N nearest-neighbour approximate three-dimensional locations of the plurality of approximate three-dimensional locations and the N nearest-neighbour three-dimensional locations of the plurality of three-dimensional locations; using the rotation matrix to attempt to register the plurality of approximate three-dimensional locations with the plurality of three-dimensional locations; and estimating an accuracy of the attempted registration to establish authenticity of the test component.

The communication equipment may comprise means for downloading reference data from the cloud, the Internet, and/or some local or remote data store.

The x-ray apparatus may comprise a digital tomosynthesis system, including a flat panel array of emitters, a detector and a reconstruction processor. However, other forms of x-ray acquisition are also envisaged.

The processor unit may comprise a general-purpose computer processor, or other suitable processor.

### BRIEF DESCRIPTION OF THE DRAWINGS

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIG. 1 shows the nearest neighbours to rotation centres of a reference dataset and a test dataset.

FIG. 2 shows a series of histograms, each respectively showing effectiveness of the approach taken.

### DETAILED DESCRIPTION

The present invention will be described with respect to certain drawings but the invention is not limited thereto but only by the claims. The drawings described are only schematic and are non-limiting. Each drawing may not include all of the features of the invention and therefore should not necessarily be considered to be an embodiment of the invention. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that operation is capable in other sequences than described or illustrated herein. Likewise, method steps described or claimed in a particular sequence may be understood to operate in a different sequence.

Moreover, the terms top, bottom, over, under and the like in the description and the claims are used for descriptive purposes and not necessarily for describing relative positions. It is to be understood that the terms so used are interchangeable under appropriate circumstances and that operation is capable in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Similarly, it is to be noticed that the term “connected”, used in the description, should not be interpreted as being restricted to direct connections only. Thus, the scope of the expression “a device A connected to a device B” should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other. For instance, wireless connectivity is contemplated.

Reference throughout this specification to “an embodiment” or “an aspect” means that a particular feature, structure or characteristic described in connection with the embodiment or aspect is included in at least one embodiment or aspect of the present invention. Thus, appearances of the phrases “in one embodiment”, “in an embodiment”, or “in an aspect” in various places throughout this specification are not necessarily all referring to the same embodiment or aspect, but may refer to different embodiments or aspects. Furthermore, the particular features, structures or characteristics of any one embodiment or aspect of the invention may be combined in any suitable manner with any other particular feature, structure or characteristic of another embodiment or aspect of the invention, as would be apparent to one of ordinary skill in the art from this disclosure, in one or more embodiments or aspects.

Similarly, it should be appreciated that in the description various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Moreover, the description of any individual drawing or aspect should not necessarily be considered to be an embodiment of the invention. Rather, as the following claims reflect, inventive aspects lie in fewer than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the term “at least one” may mean only one in certain circumstances. The use of the term “any” may mean “all” and/or “each” in certain circumstances.

The principles of the invention will now be described by a detailed description of at least one drawing relating to exemplary features. It is clear that other arrangements can be configured according to the knowledge of persons skilled in the art without departing from the underlying concept or technical teaching, the invention being limited only by the terms of the appended claims.

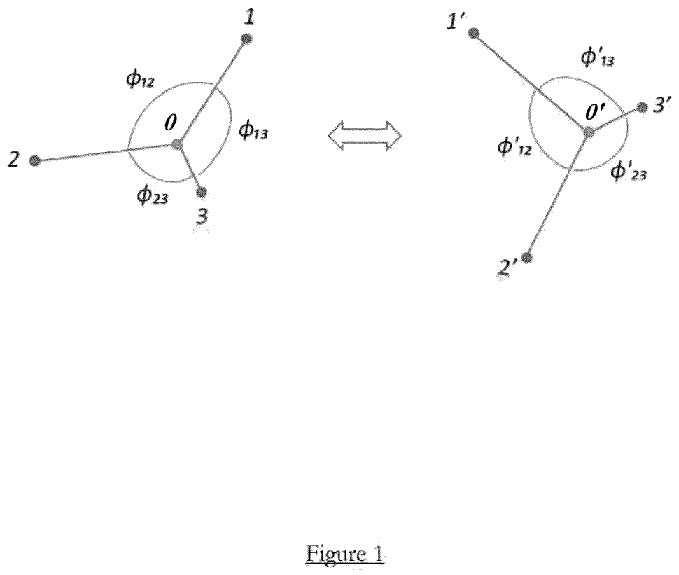

FIG. 1 shows three closest neighbours 1, 2, 3 in a reference dataset to a rotation centre 0, and the angle between vectors \vec{01} and \vec{02} as Φ₁₂, the angle between vectors \vec{01} and \vec{03} as Φ₁₃, and the angle between vectors \vec{02} and \vec{03} as Φ₂₃, when compared to three closest neighbours 1′, 2′, 3′ in a test dataset to a rotation centre 0′, and the angle between vectors \vec{0′1′} and \vec{0′2′} as Φ′₁₂, the angle between vectors \vec{0′1′} and \vec{0′3′} as Φ′₁₃, and the angle between vectors \vec{0′2′} and \vec{0′3′} as Φ′₂₃.

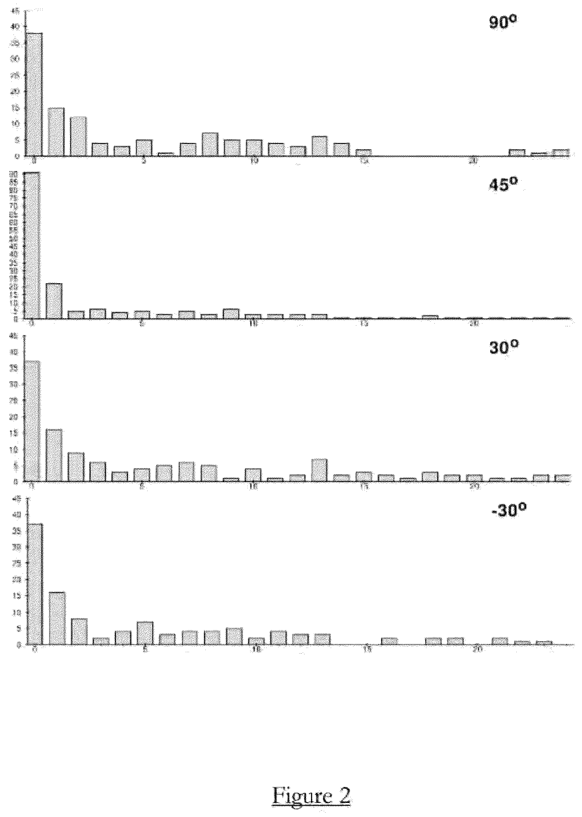

FIG. 2 shows a series of histograms, each respectively showing effectiveness of the approach taken at a variety of angular offsets. That is, the first histogram shows the results where the test dataset was obtained at an angular offset of 90 degrees from the angle at which the reference dataset was obtained, the second histogram shows the results where the test dataset was obtained at an angular offset of 45 degrees from the angle at which the reference dataset was obtained, the third histogram shows the results where the test dataset was obtained at an angular offset of 30 degrees from the angle at which the reference dataset was obtained, and the fourth histogram shows the results where the test dataset was obtained at an angular offset of −30 degrees (i.e. 30 degrees in an opposite sense to the third histogram) from the angle at which the reference dataset was obtained. The abscissa of each shows the distance between corresponding points (in the test dataset and the reference dataset) in terms of an average bounding box size. Numbers are arbitrary but the maximum distance of the histograms' abscissa is about three standard deviations of an average bounding box size. The ordinate indicates the number of matches at a given distance.

The first dataset gives 123 perfect matches out of 177. The second, 174 out of 177. While the third, 127 out of 177, and the last one gives only 112 out of 177. In terms of probability the last has the lowest: 63% of matches, while the second has the highest: 98%.

1. A method of authenticating a component against reference data, the component provided with a plurality of fiducial markers embedded therein, the reference data comprising:
a reference dataset comprising a plurality of three-dimensional locations of respective reference fiducial markers in a reference component;
a rotation centre corresponding to one of the plurality of three-dimensional locations; and
respective reference distances between the rotation centre and N nearest-neighbour three-dimensional locations of the plurality of three-dimensional locations to the rotational centre, where N is at least three;
the method comprising the steps of:
(a) providing a test dataset comprising a plurality of approximate three-dimensional locations of test fiducial markers in a test component;
(b) for a first one of the plurality of approximate three-dimensional locations, determining respective first approximate distances between the first one of the plurality of approximate three-dimensional locations and N nearest-neighbour approximate three-dimensional locations of the plurality of approximate three-dimensional locations;
(c) comparing the first approximate distances to the reference distances to establish whether the first one of the plurality of approximate three-dimensional locations corresponds to the rotation centre;
(d) if the first one of the plurality of approximate three-dimensional locations corresponds to the rotation centre, calculating a rotation matrix between the test dataset and the reference dataset, about the rotation centre, based on the N nearest-neighbour approximate three-dimensional locations of the plurality of approximate three-dimensional locations and the N nearest-neighbour three-dimensional locations of the plurality of three-dimensional locations;
(e) using the rotation matrix to attempt to register the plurality of approximate three-dimensional locations with the plurality of three-dimensional locations; and
(f) estimating an accuracy of the attempted registration to establish authenticity of the test component; but
(g) if the first one of the plurality of approximate three-dimensional locations does not correspond to the rotation centre, steps (d) to (f) are skipped for the first one of the plurality of approximate three-dimensional locations, before proceeding with steps (b) to (f) for a second one of the plurality of approximate three-dimensional locations;
wherein calculating the rotation matrix comprises calculating the rotation matrix:
$$A = ( \begin{matrix}{a}_{00} & {a}_{01} & {a}_{02} \\ {a}_{10} & {a}_{11} & {a}_{12} \\ {a}_{20} & {a}_{21} & {a}_{22}\end{matrix} )$$
by solving the equation:
$${a}_{i} = {( {BB}^{T} + α I )}^{- 1} {Bc}_{i}$$
where:
$${a}_{i} = {( {a}_{i 0} , {a}_{i 1} , {a}_{i 2} )}^{T}$$
and in which:
$${c}_{i} = {( {c}_{i}^{( 0 )} , … , {c}_{i}^{( n )} )}^{T}$$
and:
$$C = ( \begin{matrix}{c}_{0}^{( 0 )} & … & {c}_{0}^{( n )} \\ {c}_{1}^{( 0 )} & … & {c}_{1}^{( n )} \\ {c}_{2}^{( 0 )} & … & {c}_{2}^{( n )}\end{matrix} )$$
is a matrix containing three-dimensional coordinates of n locations in the reference/test dataset, and:
$$B = ( \begin{matrix}{b}_{0}^{( 0 )} & … & {b}_{0}^{( n )} \\ {b}_{1}^{( 0 )} & … & {b}_{1}^{( n )} \\ {b}_{2}^{( 0 )} & … & {b}_{2}^{( n )}\end{matrix} )$$
is a matrix containing three-dimensional coordinates of the corresponding n locations in the test/reference dataset, I is the identity matrix, a is a regularization parameter.

2. The method of authenticating of claim 1, further comprising the step of repeating steps (b) to (f) for a further one of the plurality of approximate three-dimensional locations.

3. The method of authenticating of claim 2, further comprising the step of comparing the accuracy starting from the first one of the plurality of approximate three-dimensional locations with the accuracy starting from the further one of the plurality of approximate three-dimensional locations.

4. An authentication device for authenticating a component against reference data, the component provided with a plurality of fiducial markers embedded therein, the device comprising:
communication equipment for accessing reference data, the reference data comprising:
a reference dataset comprising a plurality of three-dimensional locations of respective reference fiducial markers in a reference component;
a rotation centre corresponding to one of the plurality of three-dimensional locations; and
respective reference distances between the rotation centre and N nearest-neighbour three-dimensional locations of the plurality of three-dimensional locations to the rotational centre, where N is at least three;
x-ray apparatus for acquiring a test dataset, the test dataset comprising a plurality of approximate three-dimensional locations of test fiducial markers in a test component;
a processor unit for carrying out the steps of:
for a first one of the plurality of approximate three-dimensional locations, determining respective first approximate distances between the first one of the plurality of approximate three-dimensional locations and N nearest-neighbour approximate three-dimensional locations of the plurality of approximate three-dimensional locations;
comparing the first approximate distances to the reference distances to establish whether the first one of the plurality of approximate three-dimensional locations corresponds to the rotation centre;
if the first one of the plurality of approximate three-dimensional locations corresponds to the rotation centre, calculating a rotation matrix between the test dataset and the reference dataset, about the rotation centre, based on the N nearest-neighbour approximate three-dimensional locations of the plurality of approximate three-dimensional locations and the N nearest-neighbour three-dimensional locations of the plurality of three-dimensional locations;
using the rotation matrix to attempt to register the plurality of approximate three-dimensional locations with the plurality of three-dimensional locations; and
estimating an accuracy of the attempted registration to establish authenticity of the test component; but
if the first one of the plurality of approximate three-dimensional locations does not correspond to the rotation centre, the above steps are skipped for the first one of the plurality of approximate three-dimensional locations, before proceeding with the above steps for a second one of the plurality of approximate three-dimensional locations;
wherein calculating the rotation matrix comprises calculating the rotation matrix:
$$A = ( \begin{matrix}{a}_{00} & {a}_{01} & {a}_{02} \\ {a}_{10} & {a}_{11} & {a}_{12} \\ {a}_{20} & {a}_{21} & {a}_{22}\end{matrix} )$$
by solving the equation:
$${a}_{i} = {( {BB}^{T} + α I )}^{- 1} {Bc}_{i}$$
where:
$${a}_{i} = {( {a}_{i 0} , {a}_{i 1} , {a}_{i 2} )}^{T}$$
and in which:
$${c}_{i} = {( {c}_{i}^{( 0 )} , … , {c}_{i}^{( n )} )}^{T}$$
and:
$$C = ( \begin{matrix}{c}_{0}^{( 0 )} & … & {c}_{0}^{( n )} \\ {c}_{1}^{( 0 )} & … & {c}_{1}^{( n )} \\ {c}_{2}^{( 0 )} & … & {c}_{2}^{( n )}\end{matrix} )$$
is a matrix containing three-dimensional coordinates of n locations in the reference/test dataset, and:
$$B = ( \begin{matrix}{b}_{0}^{( 0 )} & … & {b}_{0}^{( n )} \\ {b}_{1}^{( 0 )} & … & {b}_{1}^{( n )} \\ {b}_{2}^{( 0 )} & … & {b}_{2}^{( n )}\end{matrix} )$$
is a matrix containing three-dimensional coordinates of the corresponding n locations in the test/reference dataset, I is the identity matrix, α is a regularization parameter.
